(19) United States
(12) Patent Application Publication
(10) Pub. No.: US 2009/0222362 A1
(43) Pub. Date: Sep. 3, 2009

(54) METHOD FOR HANDLING OF A BANK NOTE AND SYSTEM THEREFORE

(76) Inventors: Jan Stood, Hammaro (SE); Ola Patriksson, Karlstad (SE); Christian van Oostrum, Karlstad (SE); Thomas Erdtman, Santa Pola (ES)

Correspondence Address: MANELLI DENISON & SELTER, 2000 M STREET NW SUITE 700, WASHINGTON, DC, 20036-3307, US

(21) Appl. No.: 12/093,809

(22) PCT Filed: Nov. 24, 2006
(86) PCT No.: PCT/SE2006/050505

§ 371 Date: Jan. 13, 2009

Related U.S. Application Data
(60) Provisional application No. 60/739,922, filed on Nov. 28, 2005.

(30) Foreign Application Priority Data
Nov. 24, 2005 (SE) 0502589.5

(51) Int. Cl. G06Q 40/00; G07F 19/00; G06Q 10/00

(52) U.S. Cl. 705/30; 705/35; 235/379

(57) ABSTRACT

The present invention relates to a method for handling of a plurality of bank notes comprising the following steps: a) collecting said plurality of bank notes (1) at a location of commerce (2), b) safe-keeping said bank notes (1), wherein the method also comprises c) registering each one of said bank notes (1) by use of an identity code (3) of each bank note (1), in connection with, or subsequent to, collecting said bank notes (1), d) registering and designating said banknotes (1) as being invalid, to minimise the risk of theft of said bank notes (1). The invention also comprises a system for handling of a plurality of bank notes according to the method of the invention.

### FIELD OF THE INVENTION

The present invention relates to a method for handling of a bank note and a system therefore. In particular, the present invention relates to the handling of cash and other bank notes used in commerce, hereinafter referred to as a bank note/bank notes, which are exposed to the risk of theft. In particular, the present invention is directed to a method for handling of a bank note comprising collecting a bank note at a location of commerce and safe-keeping the bank note.

### BACKGROUND OF THE INVENTION

Bank notes handled in commerce and banks are exposed to the risk of theft. In particular, during the transport of bank notes between different places, like the transport from a shopping centre to a bank, or from a shop to a cash deposit machine, or from a central loading and filling station to a cash dispenser, that risk is increased. Banks, shops, and central loading and filling stations that handle a large amount of bank notes in a single place as well as cash dispensers also are exposed to an increased risk of robbery.

Various safety systems have been developed during the years in order to increase security in relation to the handling of bank notes, e.g. by means of minimizing the amount of cash in cashboxes in shops and banks, such as by the use of a cash deposit safety box placed close to the cashier's desk, and which normally can not be opened by the cashier. Furthermore, internal tube deposit systems are used by means of which the cash can be transported from the cashiers check to a special deposit place. Boxes used for transportation of bank note containers have been reinforced. Moreover, bank note containers have been equipped with paint ampoules that release paint over the bank notes marking them as invalid if the containers are stolen and opened in an inappropriate way. Systems for remote release of paint ampoules are also known. Transportation and delivery of bank notes is mostly handled by valuables transport service performers having special, armoured vehicles and several employees in each vehicle. Along with increased security, the theft methods tend to be more violent, exposing the people who work with the handling of bank notes to a greater risk.

Attempts have been made to urge people to use credit cards, in order to reduce the amount of cash in circulation. However, there still remains a need for bank notes, e.g. due to the simple fact that people want to be able to make anonymous payments, and also due to the fact that everybody can not have or does not want to have a credit card.

### SUMMARY OF THE INVENTION

It is an object of the present invention to offer a method for handling of bank notes by which the drawbacks of the present known systems are eliminated or at least reduced. In particular, it is an object of the present invention to offer a system for handling of bank notes by which the risk of robbery can be totally eliminated. This can be achieved by a method for handling of a bank note comprising collecting a bank note at a location of commerce and safe-keeping the bank note, characterised in that it comprises registering an identity code of said banknote in connection with or subsequent to collecting said bank note, thereby designating the banknote as invalid.

By means of the invention, the handling and safe keeping of a bank note, for example in a cash box at a cashier's desk, requires less protection since the bank note is invalid once the identity code has been registered.

In the description herein, the term identity code should be recognised as any kind of identification means, for example a serial number, a bar-code, an RFID-transponder (Radio Frequency Identification) or other unique mark of identification. The term computer readable file should be recognised as any kind of data storing and/or transferring medium compatible to a computer program, for example a computer program file, a smart card, an applet, a carrier wave, and it should also be recognised as a file that can be both readable and writeable. The term bank note should be recognised as cash/paper money, a check or any other payment means that is valid for payment by anyone at any time. The term location of commerce is to be recognised as any place at which a commercial transaction can take place, a shop, a bank, a currency exchange office, a cash dispenser and a cash-operated fuel pump for example. The term scanning operation should not be limited to an optical operation, but should be recognised to involve any kind of conceivable identification procedure that can be interpreted and executed by a computer program, like for example a radio frequency identification procedure (RFID). Consequently, the term scanning apparatus should be recognised as any conceivable apparatus being able to perform the acknowledgement of a unique identity code, for the invalidation and validation operation.

According to another aspect of the invention, the method of the invention also comprises registering said identity code at a later occasion of revalidation, thereby designating the banknote as valid. Hereby, the handling and safe keeping of a bank note requires less protection since the bank note is maintained in invalid condition until the identity code has been registered in connection with a validation procedure. Preferably, the revalidation is done when the bank note is put back in to circulation, for instance in connection with a withdrawal in a cash dispenser or in a bank.

By means of a communication net, e.g. the Internet, dedicated cables, LAN, etc., the registration of the identity code can be reported to a central computing device that can be arranged to process the information in an appropriate manner. The central computing device may be connected to a memory device arranged to store identity codes. Hereby, information of which bank notes that are valid and/or invalid may be safeguarded and the information may also be distributed to others that may have use of that information. In order to communicate with the central computing device, at least one location of commerce may be provided with a local computing device.

According to still another aspect of the invention, the method of the invention also comprises the registering of said identity code by means of an invalidation device, which makes the registering of the identity code a safe, quick and easy operation that can be incorporated in today's existing bank note handling systems. In a preferred embodiment of the invention, the registering is performed by means of a scanning apparatus. Preferably, the validation device may be integrated into the same device as the invalidation device, for instance a cash register, and in an even more preferred embodiment of the invention, the invalidation and the validation is performed by the same device and the operation of the device may be automatically controlled by the software in the cash register, which makes the handling secure and smooth for the person working with the handling e.g. in a bank, a shop etc.

According to still another aspect of the invention, the invalidation and revalidation are performed at geographically separated locations, and the bank note is physically transported between the first and second locations. The transportation of the bank note to the deposit in a bank or to a cash deposit machine, and the transportation of the bank note from the central loading and filling station to a cash dispenser can thereby be done substantially without any risk of robbery, since the bank note is practically useless until the identity code is noted at the location of revalidation and thereby activated.

According to still another aspect of the invention, the status of the registered identity code should be checked against the status for the actual identity code stored in the memory device, for example via the communication net which makes the control fast and secure. Furthermore, the invalidation device by which the identity code is registered at the location of commerce should be arranged to communicate with the central computing device via the communication net, thereby providing a method for automatic and preferably instant invalidation of the bank note. By the communication net, the status of the bank note registered in the memory unit can be reported to the location of commerce. For instance, the invalidation device can be arranged to give an alert if the bank note is reported as being designated as invalid already, or whether the bank note is valid or invalid, whatever is desired.

According to still another aspect of the invention, the revalidation device by which the identity code is noted at a later occasion, should preferably be arranged to communicate with the central register via the communication net, thereby providing a method for automatic and preferably instant activation of the bank note, in the same manner as described above in relation to the inactivation procedure.

According to another aspect of the invention, the invalidation and revalidation devices should be arranged to communicate with the computer readable file via encrypted and/or coded communication, thereby providing for a high security with regard to the invalidation and validation of the bank note.

According to still another aspect of the invention, a local computing unit may be arranged to report the stored identity code to the central computing device. By the method of the invention, the local computing device can be arranged to store identity codes in a local storing medium, and to report the stored identity codes to the central computing device at a later occasion, for instance when the cash register is cleared at the end of the day, i.e. an expensive on-line communication system is not needed. Hereby, the invention offers the possibility to provide a less expensive system by which the identity codes can be reported for example via a mobile phone or via existing credit card systems. In this way, even small shops with relatively low sales amounts can afford a system that offers the bank notes to be handled and transported to deposit in a secure manner, and considerably reduce the risk of being robbed.

According to yet another aspect of the invention, the central computing device and/or the local computing unit can be arranged to authorise a specific validation device to validate the bank note under the condition that said validation device is authorised to validate the bank note, thereby preventing unauthorised validation of the bank note in another location. By the invention, the risk of false bank notes or stolen bank notes being validated by for instance a stolen scanning apparatus is eliminated. For example, a company that is responsible for the transportation of the bank notes from the first location can dedicate the bank notes to a specific scanning apparatus located at a second location, for instance by a bank note dispenser. If the bank notes are stolen during the transportation, validation of the bank notes by another scanning apparatus than the dedicated one will be impossible, or in case it is desired, an indication can be given to authorised persons that an impropriate validation is being performed of stolen bank notes.

According to yet another aspect of the invention the identity codes of invalidated bank notes listed in the memory unit should be made public, for example in a public register on the Internet. Hereby, any person can check the identity code manually to see if the bank note is valid or not, such as persons doing business in private or someone that suspects having received an invalid bank note. This can of course also be used in small shops that lack the communication system, in case someone is trying to pay with false or stolen bank notes.

The invention also relates to a system for handling of a bank note and according to one aspect of the invention, the system should comprise an invalidation device arranged to register an identity code on a bank note, a computer readable file, a communication net and a central computing device comprising a memory unit, the invalidation device being arranged to communicate with the first scanning apparatus and the computer file to report the identity code to the computer readable file to designate the bank note as invalid.

According to a further aspect of the invention, the system should also comprise a scanning apparatus which is arranged to note the identity code of the bank note and a computer program arranged to report said identity code to said computer readable file thereby designating the bank note as valid.

According to another aspect of the invention, the system should comprise at least two scanning apparatuses which are geographically separated. Thereby, the transportation of the bank note may be performed in a secure manner, by which the scanning apparatus at the first location will inactivate the bank note and the bank note will be activated by the scanning apparatus at the second location.

### DESCRIPTION

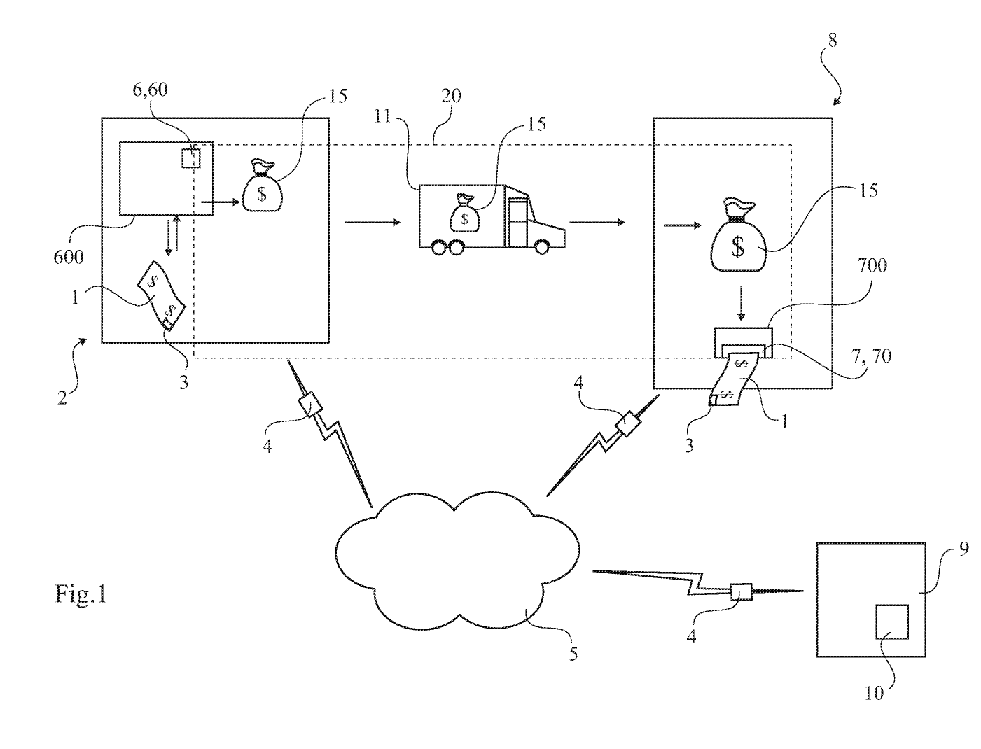

FIG. 1 shows a schematic diagram of a preferred embodiment according to the invention, in one possible mode of use,

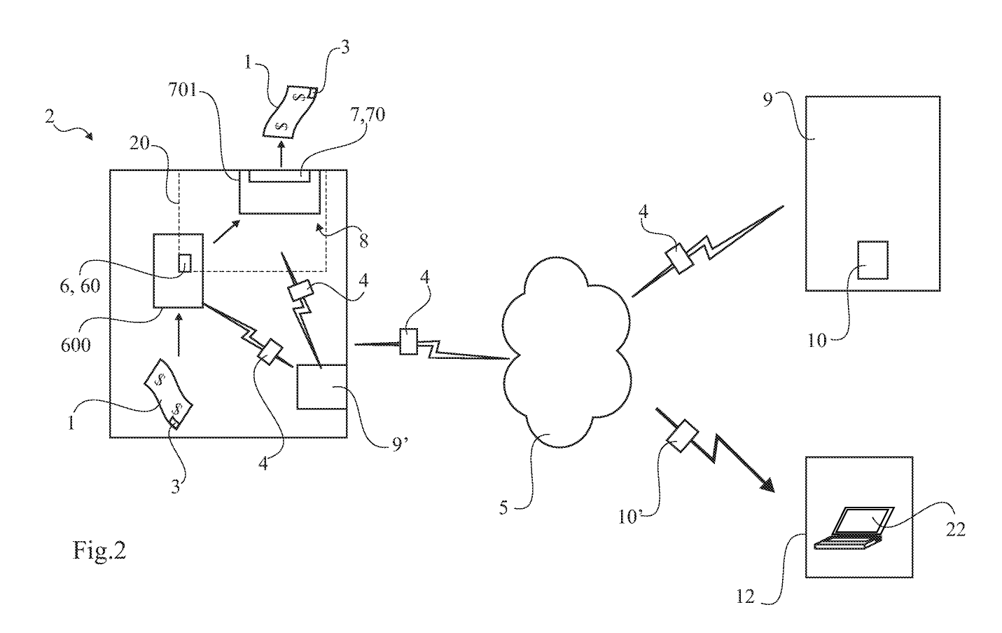

FIG. 2 shows a similar view as FIG. 1; but presents another kind of function in accordance with the invention,

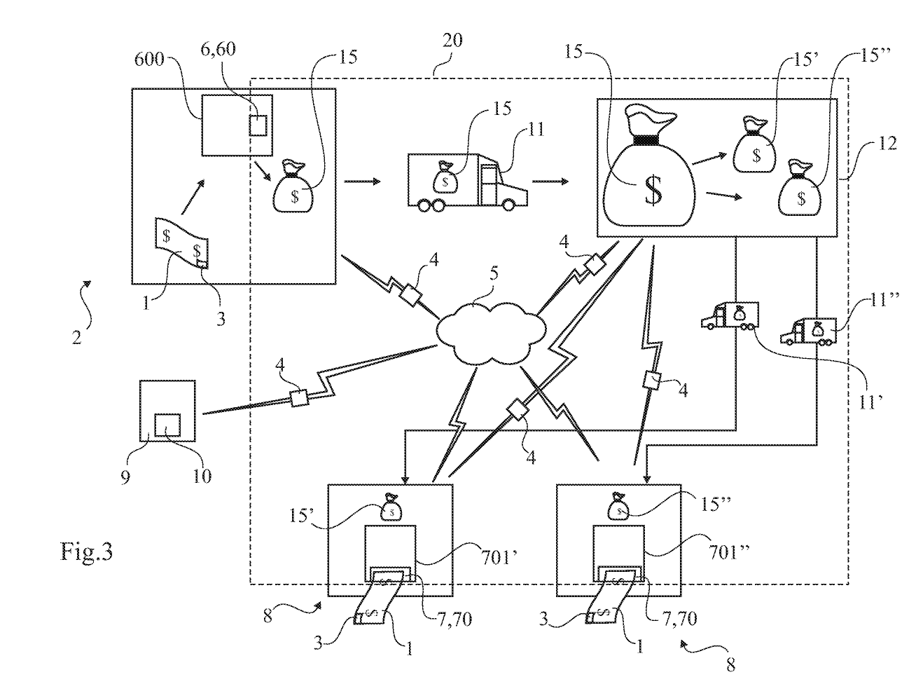

FIG. 3 shows a further embodiment in accordance with the invention, and

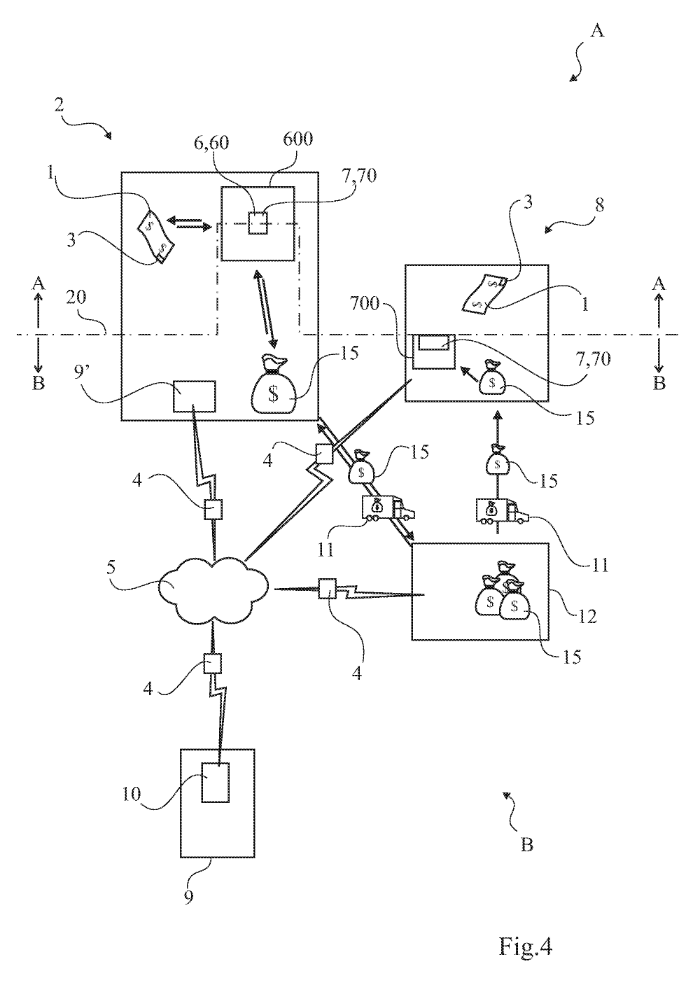

FIG. 4 shows a flow sheet of the handling and transportation in a different manner in accordance with the invention.

### DETAILED DESCRIPTION

It is an object of the invention to offer a method for safe handling of bank notes. In particular, the safe-keeping and transportation of bank-notes is concerned. It is an object of the invention to offer a method by which a bank note can be made useless in-between the times that the bank note is used in an action of commerce. This can be obtained by a method according to the invention and will be described with reference to the enclosed drawings.

FIG. 1 shows a principal layout of an intended flow of a bank note 1 according to a preferred mode of the invention. There is shown a first location of commerce 2, e.g. a shop, a store in a mall, a cash exchange centre, etc. At the first location of commerce 2 there is a cash registration unit 600, e.g. cash register, which is arranged with some kind of invalidation device 6, including a first scanning apparatus 60 that is able to register an identity code 3 of the bank note 1, e.g. a dollar bill. In the preferred embodiment the scanning apparatus 60 is integrated into the traditional cash handling system, being automatic, in the cash register 600.

The scanning apparatus 60, can be connected to a communication net 5. A memory unit 10 is located within a central computing device 9. The central computing device 9 is preferably positioned in an extraordinary safe environment, e.g. in a protected bunker deep underground.

Further, FIG. 1 shows that there is a vehicle 11 for transportation of collected bank notes 15 from the first location of commerce 2 to a second location of commerce 8. This second location of commerce 8 may for instance be a bank. Within the second location of commerce 8 there is shown a cash delivering apparatus 700 comprising a validation device 7 and a scanning apparatus 70, by means of which the unique identification code 3 of each bank note 1 may be registered. In FIG. 1, the area marked with the dotted line 20, represents the area within which the bank note is invalid.

The function of the system as shown in FIG. 1 is as follows. At the first location of commerce 2 staff collects a bank note 1 in connection with a payment. The staff person then puts the bank note 1 into the cash register 600, which simultaneously and automatically by means of the invalidation unit 6 registers the unique identity code 3 of the bank note. The identity code 3 may be stored in a computer readable file 4 within the cash register 600. The computer readable file 4 is then automatically transmitted by means of the communication net 5 to the central computing unit 9 and registered and thereby the identity code 3 of that bank note 1 is registered in the memory unit 10 as being invalid. From this moment the bank note can no longer be actively used in commerce. Hence, as soon as this registration has occurred, the value of the bank note is practically merely the value of the paper that it is printed on. The bank note 1 may, after having been invalidated, be stored in any convenient manner, which does not require any higher level of security, since it is more or less worthless in its invalidated condition. The invalidated bank note 1 together with other invalidated notes will be collected in a storage device 15, e.g. collecting box. The transportation vehicle 11, which in this case need not be a vehicle having enhanced security protecting means, thereafter collects the storage device 15 and transports it by means of the vehicle 11 to another location 8. This location may for instance be a bank. At the bank 8 the invalidated bank notes 1 are stored in the invalidated condition, which means that less security is needed, until a revalidation is desired. In connection with revalidation the bank note 1 is processed in a revalidation device 7, which includes a scanning apparatus 70. In this case the scanning apparatus 70 may be integrated in a cash dispensing device 700, located next to an employee of the bank, who may supply a customer with validated bank notes 1. In the scanning apparatus 70 the identification code 3 of an invalid banknote 1 will be registered and transmitted to the central computing device 9 by means of the communication network 5. In the central computing unit 9 the identity code 3 will be processed and the bank note 1 will be registered in the memory device 10 as being valid. Thereafter, the bank note 1 may be used again in commerce, e.g. by handing it over to a bank client making a cash withdrawal, e.g. at the cashier's desk. Preferably, the validation of the bank note is performed in direct connection with this transaction.

Accordingly, the above described embodiment of the invention clearly indicates that enormous savings may be achieved by means of the invention, since by means of the invention the bank notes are useless at locations where normally robbery can be expected, e.g. in connection with storage and/or transportation of large amount of bank notes.

FIG. 2 shows a different mode of using the invention. By way of example only the same kind of location for commerce 2 is shown as in FIG. 1, but presenting some different features. In communication with the scanning apparatus 60 there is a computer device 9′, which is positioned within an adjacent allocation. The computer device 9′ is in communication with the central computing device 9 by means of a communication net 5, e.g. the Internet, dedicated cables, LAN, etc. Within the central computing device 9 there is a memory unit 10. The central computing device 9 is preferably positioned in an extremely safe environment, e.g. in a protected bunker deep underground. In connection with the location of commerce 2 there is arranged a cash automate 701, e.g. in one of the walls of the store 2. The cash automate 701 may be an ordinary kind of cash automate, i.e. having an automated cash dispensing device and also some kind of reading/scanning unit, etc., but also including a scanning apparatus 70 adapted for the validation device 7 (either in integrated form to form a common unit with the traditional reading/scanning unit or in separate form next to the traditional reading/scanning unit) able to transmit information to the central computing unit 9. Here it is shown that instead of direct transmitting information via the communication network 5, it is also possible to have a local server unit 9′ for routing the information to and from the central computing unit 9. In other aspects, the setup of the system is similar to what is described in conjunction with FIG. 1.

The function of the system as shown in FIG. 2 is as follows. Again, a staff person at the store 2 will collect the bank note. The staff person then puts the bank note 1 into the cash register 600, which simultaneously and automatically by means of the invalidation device 6 registers the unique identity code 3 of the bank note and transmits that information to the local server 9′. The transmission of the identity code 3 from the cash register 600 to the server 9′ is preferably achieved by transmitting in a computer readable file 4. Thereafter, the bank note 1 may be transferred to the location 8 of the cash automate 701 in which it is stored in an invalid condition. In connection with a cash withdrawal made at said cash automate 701 the bank note 1 will be supplied by means of the cash automate 701 and at the same time the scanning apparatus 70 within the revalidation device 7 will register the identity code 3 and transmit it to the central computing unit 9 via the local computer device 9′, where it will be registered as valid in the memory device 10 and thereby again be useable for payment. Accordingly, the staff, or some staff, at the store 2 may easily perform the loading of the cash automate 701. Hereby, the need of transportation of bank notes is eliminated. Of course, the system may be combined with transportation as described in FIG. 1.

According to still another aspect of the invention the identity codes reported to the memory unit 10 as being invalid, may be made public via a public register 10′, for instance via the Internet. Hereby, any one that suspects having received an invalid bank note may check the identity code in the register 10′ via a PC 22. According to the invention, other services may be provided in order to make this check, for instance via telecommunication.

It is also understood that the systems described in FIG. 1 and 2 also may be combined in any other appropriate way, as showed in FIG. 3. For instance, it is possible that the validation of bank notes is performed in a cash automate 701 also in connection with FIG. 1, but with the vehicle transporting the bank notes from a central packing and loading station 12 to dedicated cash automate. Hence, in such an embodiment the staff at the central packing and loading station 12 would register the dedicated bundle of bank notes 15′, 15″ to a certain cash automate 701′, 701″ and the transport vehicle 11′, 11′ would transfer them to said dedicated cash automate 701′, 701″, to be validated in a validation procedure of the same manner as described in connection with FIG. 2. Hence, it is understood that the central computing unit 9 may be supplemented with software that would control that a specific cash automate is authorised to validate the bank note 1 under process. Hence, according to that embodiment such cash dispensers would have to be provided with a certain identity that may be controlled by the central computing unit 9.

FIG. 4 shows a flow sheet of the principle of handling a bank note according to the present invention and the means for performing the operations according to the method. According to the invention, the bank note 1 is either valid or invalid as means of payment. In FIG. 4, the line 20 represents the dividing line between the invalid and valid condition. The area denoted A refers to the handling of valid bank notes and the area denoted B refers to the handling of invalid bank notes. At the interface, e.g. at the dividing line 20, between the two handling areas, different locations of commerce 2, 8 may exist. As can be seen in FIG. 1, these locations of commerce 2, 8 symbolize the only legitimate way by which the bank note can be handled from one area to the other. According to an object of the invention, the flow of invalid bank notes can be controlled and validation of false or stolen bank notes can be prevented.

The system for handling of the bank note according to the invention is characterised in that it comprises an invalidation device 6 arranged to register an identity code 3 of a collected bank note 1 by means of a scanning apparatus 60 in a first location of commerce 2. The invalidation device 6 is arranged to communicate via a communication net 5, with a central computing device 9 comprising a memory unit 10, in order to report the registered identity code 3 to the central computing device 9 by means of a computer readable file. In the central computing device 9 the data contained in the computer readable file 9 is processed and the bank note is registered in the memory unit 10 as being invalid. In FIG. 4, is also shown that a validation of bank notes 1 may also take place at the first location of commerce 2. If the location of commerce is a shop, a collected bank note 1 may be invalidated at a first occasion and be stored or safe-kept within the shop until a later occasion, when the bank note may be validated in connection with a costumer being given change. At the end of the day, the surplus of bank notes 15 may be transported 11 to deposit, in a conventional manner. If the location of commerce 2 is a bank or an exchange office, bank notes may be transported to and from the location 2. Preferably, the bank notes will be stored in invalid condition within the office and the validation will preferably take place in connection with a staff handling over the money to a client.

At the cashier's desk, the validation device 7 and the invalidation device 6 may preferably be located such that easy handling of the bank notes can be achieved. In one embodiment of the invention, the invalidation device 6 may be placed at the cashier's desk in such a way that the costumer himself may put the bank note into the device when paying the goods or making the transaction. The invalidation device 6 may be connected with the cashbox or a remote deposit and the invalidated bank notes 1 may be automatically directed to the cash box or deposit. In case of change, the procedure can be run in the opposite direction and the bank note 1 can be automatically handled to the costumer via the validation device 7. Preferably, the invalidation device 6 and the scanning apparatus 60 can also act to perform the validation of the bank note, i.e. the invalidation device 6 and validation device 7 being the same device.

FIG. 4 also shows the principle of transportation of the invalidated bank notes 15. The handling of invalid bank notes takes place on the opposite side of the dividing line 20 at the area denoted B, where the invalidated bank notes may be transported to and from a first location of commerce 2, to a central packing and loading station 12 and to a second location of commerce 8. At the second location of commerce 8 validation takes place and consequently a validation device 7 is provided. By the method of the invention, the risk of robbery is substantially eliminated and it is obvious that the invention provides a method of handling bank notes by which the transportation of bank notes between different locations may take place under less stringent security arrangements. This will result in cost savings and it will also result in a more safe and secure handling of the bank notes at any point within the system.

The method according to the invention comprises the following steps: a bank note 1 is collected at a position of commerce 2, for instance a shop. An identity code of the bank note is registered at the time of payment. The registering of the bank note can be performed by a scanning apparatus 6, preferably located at the cashier's desk. In a simple embodiment of the invention, the registration may just as well be made manually and the identity code can be reported to the computer readable file by manually entering the key code via a computer, a mobile cell phone or some other communication device. After registering the identity code of said bank note the bank note is normally safe kept until a later occasion when the bank note is transported to deposit.

According to the invention, the identity code 3 of the bank note 1 is registered in a computer readable file 4, thereby designating the bank note as being invalid. At a second occasion, invalidated bank notes can be made valid. This is obtained by a second scanning operation, in which the identity code 3 of the bank note is noted and the identity code 1 is reported to said computer readable file 4. In case of stolen or false bank notes being circulated, the central computing device 9 is preferably arranged to process the information transmitted via the communication net 5 to alert any incorrectness in connection with the invalidation or validation procedure. By means of the invention, a stolen or false bank note can not be used for payment. In the same way, attempts to validate stolen or false bank notes may be prevented, since the central computing unit 9 may keep a record of the identity codes of bank notes reported as stolen. Also, false bank notes can be identified, since the identity code is often copied, or identity codes of destructed bank notes may be used, and the central computing unit 9 may keep a record of this as well.

The central computing unit 9 may also be arranged to update the computer readable file 4 with the current status of the identity codes in the memory unit 10 and in an on-line system the updated information may be instantly supplied to the invalidation or validation device by means of a local computer unit 9′. In case of a false or stolen bank note being circulated, the central computing unit 9′ may check the status in computer readable file 4 and alert if the bank note is invalid. The computer program may also be arranged to alert if the bank note is either valid or invalid if that is desired. Preferably the scanning apparatus as well as the computer program communicate with the computer readable file by encrypted and/or coded communication.

According to another aspect of the invention, false or stolen bank notes can be traced since the central computing device 9 can be arranged to report if such bank notes are detected. Hence, according to this aspect, the invalidation and validation devices would have to be provided with a certain identity that can be controlled by the central computing unit 9.

At the time of transportation of the bank notes, safety boxes may be used that themselves may be equipped with identity codes and they may also be equipped with a memory unit that may give information about the identity codes of the bank notes being transported, but preferably, this information is transmitted to the central computing unit 9 in advance, such that this valuable information is transmitted separately.

### ALTERNATIVE EMBODIMENTS OF THE INVENTION

In an alternative embodiment of the invention the invalidation and validation procedure can also be extended to comprise bank notes in circulation, but for which the proprietor desires to letting them be validated at a later occasion than in connection with the withdrawal from his/her bank account. If, for instance, a person wishes to validate a number of bank notes at one occasion and a number of bank notes at a later occasion, the bank notes can be confirmed to be valid by means of a coded confirmation procedure via a mobile cell phone or a PC, in the same manner as people can have access to his/her bank account today. This procedure can be very convenient for instance in vacation, when people often bring a lot of foreign exchange along from home.

By means of the invention, the authority in charge of printing new bank notes and destructing old ones is preferably in charge of administrating the central computing device 9 and the memory unit 10, i.e. the primary register. The authority may add the identity codes of new bank notes being put into circulation, and also to delete identity codes of bank notes being destructed.

Within the scope of the invention it should be understood that the invalidation and validation devices may communicate directly with the central computing device 9 to transmit information about the status of the identity codes to the central memory unit 10. The invalidation and validation devices may also communicate with a secondary register which may be downloaded to a local server within for instance a supermarket with several cash desks. The secondary register may be updated continuously or at intervals and the secondary register may also report to the central computing device on these occasions, in order to update the central memory unit 10. Furthermore, the invalidation and validation devices may be arranged to save the identity codes in a local storing medium within the device itself, and to send the information to the central computing device 9 at a special occasion, for instance when the cash register is closed, reported and cleared at the end of the day. It should be understood that the computer readable file may contain information about the status of every bank note, e.g. the identity code of the bank note may be marked as being valid or invalid. In another embodiment the computer readable file may contain a number of identity codes, whereby the file itself is configured to indicate that the identity codes in the file is to be marked as valid, for instance in a file sent from a cash automate.

The method can also provide means for tracking false or stolen bank notes since the location of validation (or attempt of validation) can be identified in a simple manner. In case of robbery, the identity codes of the stolen bank notes can be reported.

1-22. (canceled)

23. Method for handling of a plurality of bank notes comprising the steps:
a) collecting a plurality of bank notes at a location of commerce;
b) safe-keeping said bank notes;
c) registering each one of said bank notes by use of an identity code of each bank note, in connection with, or subsequent to, collecting said bank notes; and
d) registering and designating said banknotes as being invalid, to minimize the risk of theft of said bank notes.

24. Method according to claim 23, further comprising e) registering the identity code of said bank note at a later occasion at a location of revalidation, thereby designating the banknote as being valid.

25. Method according to claim 24, wherein said registration is communicated to a central computer device via a communication net.

26. Method according to claim 25, wherein said central computer device is in connection with a memory device arranged to store identity codes, to safeguard information of which bank notes that are valid and/or invalid.

27. Method according to claim 26, wherein at least one of said locations is provided with a local computer device in communication with said central computer device.

28. Method according to claim 24, wherein the registering of said identity code is performed by means of an invalidation device.

29. Method according to claim 24, wherein the registering of said identity code is performed by means of a validation device.

30. Method according to claim 26, wherein said identity code is checked against identity codes listed in the memory device.

31. Method according to claim 27, wherein the invalidation and revalidation devices are arranged to communicate with a central computer device comprising a memory unit.

32. Method according to claim 23, wherein the communication is performed via a communication net that enables encrypted and/or coded communication.

33. Method according to claim 23, wherein a device is arranged to alert the status of the bank note.

34. Method according to claim 33, wherein the device is an invalidation device and/or validation device.

35. Method according to claim 24, wherein the invalidation and validation are performed at geographically separated locations, and that the bank note is physically transported between the different locations of commerce.

36. Method according to claim 29, wherein at least one validation device has a unique identity.

37. Method according to claim 36, wherein said computer device is arranged to authorize a validation device to validate a bank note under the condition that said revalidation device is authorized to validate that bank note.

38. Method according to claim 23, wherein the identity code of the invalidated bank note is made public, preferably in a memory device accessible via the Internet.

39. System for handling of bank notes comprising a location of commerce, said location of commerce comprising at least one cash handling unit, wherein the system comprises an invalidation device arranged to register a plurality of bank notes by registering an identity code of each bank note, and also arranged to register and designate said bank notes as being invalid, to minimize the risk of theft of said bank notes.

40. System according to claim 39, further comprising a validation device arranged to register the identity code of the bank note and arranged to designate the bank note as being valid.

41. System according to claim 40, wherein at least one of said invalidation and/or validation devices is arranged adjacent said cash handling unit.

42. System according to claim 40, wherein at least one of said invalidation and/or validation devices is integrated with said cash handling unit.

43. System according to claim 42, wherein said cash handling unit is a cash register.

44. System according to claim 42, wherein said cash handling unit is provided with an automated cash dispenser.

45. System according to claim 44, wherein said automated cash dispenser is integrated within a cash automate.

46. System according to claim 44, wherein said automated cash dispenser is integrated in a separate validation unit.
